(19) United States
(12) Patent Application Publication
(10) Pub. No.: US 2005/0144467 A1
(43) Pub. Date: Jun. 30, 2005

(54) Unauthorized access control apparatus between firewall and router

(75) Inventor: Takeshi Yamazaki, Kawasaki (JP)

Correspondence Address: GREER, BURNS & CRAIN, LTD., Suite 2500, 300 South Wacker Drive, Chicago, IL, 60606, US

(73) Assignee: FUJITSU LIMITED

(21) Appl. No.: 10/858,854

(22) Filed: Jun. 2, 2004

(30) Foreign Application Priority Data
Dec. 26, 2003 (JP) 2003-435587

(51) Int. Cl. H04L 9/32

(52) U.S. Cl. 713/189

(57) ABSTRACT

A firewall (FW) which detects a DOS attack cuts off the DOS attack, and outputs a log indicating an attack, and designates a source IP address of the DOS attack. A filtering command for cutting off an attack is generated in a router, and transmits it to the router. The router discards a packet transmitted from the specified IP address through the filtering operation.

### BACKGROUND OF THE INVENTION

1. Field of the Invention

The present invention relates to an unauthorized access control apparatus to be operated between a firewall and a router.

2. Description of the Related Art

With the remarkable progress of communications technology in recent years, a number of information processing terminals have been connected to a network such as the Internet, etc. However, a user of an information processing terminal connected to a network is not always a conscientious user, but can be a hacker. A hacker attempts to get unauthorized access to the information processing terminals of other users to obtain confidential information without permission, operate invaded information processing terminals without permission, etc., thereby threatening the security of invaded users.

To take countermeasures against the unauthorized access, a firewall and a router are provided at the entry to an information processing terminal of a network to which the information processing terminal is connected. A firewall detects unauthorized access and cuts off the unauthorized access while a router rejects unauthorized access at an address set by a user for access rejection.

However, since the firewall conventionally conducts access control based on the access control policy of each of layers 2 through 7, it can possibly realize high-level control, but it is hard to perform the control at a high speed because the data in a packet transmitted over a network is to be identified.

The router implements the function of controlling access by hardware, and therefore can possibly perform control at a high speed. However, it is hard to realize access control using the layers 4 through 7.

Therefore, when an operation administrator refers to the access control log information at a firewall, and detects unauthorized access, the operation administrator manually sets the filtering policy on the router rejecting the corresponding traffic.

Patent Document 1 discloses a network monitor system capable of detecting unauthorized access from an external network to an in-house information network, and the source of an unauthorized packet.

Patent Document 2 discloses a filtering operation using a filtering policy of each piece of equipment such as a router, a switch, a firewall, etc. However, the conversion into a filtering policy for a different layer of other equipment is not performed, and a filtering policy is set by a security operation administrator.

Patent Document 3 discloses a system of automatically transferring the filtering hit status of a plurality of firewall apparatuses to an external management apparatus, automatically updating the optimum filtering information according to the information from each firewall, and automatically transferring and reflecting the update result on each firewall apparatus.

[Patent Document 1]

Japanese Patent Application Laid-open No. 2000-261483

[Patent Document 2]

National Publication of International Patent Application No. 2002-507295

[Patent Document 3]

Japanese Patent Application Laid-open No. 2003-233623

In the conventional technology, a firewall and a router are different nodes, and an abnormal condition detected by the firewall cannot be automatically reflected in setting of a filtering policy of a router, and it is necessary for an operation administrator to monitor the process and manually operate the settings. Furthermore, a problem where a firewall temporarily becomes overloaded has existed.

Additionally, an abnormal condition detected by a firewall cannot be coupled with a high-speed discard of unauthorized packets by setting a filtering policy in a router.

There is also the problem that the continuity of unauthorized access cannot be confirmed unless both the packet discard status by a filtering operation in a router and the packet discard status by a filtering operation in a firewall can be confirmed.

Furthermore, when a filtering policy is added to a router in response to an abnormal condition detected in a firewall, it is necessary for an operation administrator to confirm the ability to release it and issue a release instruction by accessing the router.

When a firewall detects a DOS/DDOS attack and a filtering policy is set in a router, heavy traffic occurs by using a communications line between the router and the firewall, thereby possibly disabling the operation.

When a firewall is connected through a plurality of routers, it requires a long time to designate a router which is an entry of a source traffic of a DOS/DDOS attack and apply a filtering policy of the router, and the operation stops during the process.

According to Patent Document 1, unauthorized access is detected by the cooperation between a firewall and a router. However, since the unauthorized access reaches a counterfeit server, the network between the firewall and the router is fully occupied if a large number of unauthorized access are transmitted, thereby causing the problem that an authorized packet cannot be received. Especially, in the technology according to Patent Document 1, when there is a DOS/DDOS attack, a firewall, a counterfeit server, or a detection apparatus possibly becomes inoperable, and the application of a filtering rule from the traffic monitor apparatus to the firewall and a router cannot probably be indicated from the firewall to the router due to the load by the DOS/DDOS attack.

### SUMMARY OF THE INVENTION

The present invention aims at providing an unauthorized access control apparatus capable of constantly processing authorized access at a high speed.

The unauthorized access control apparatus according to the present invention for controlling unauthorized access with a router connected to an external network cooperating with a firewall connected to the router includes: the router for specifying an address of an access source and discarding a packet transmitted from the address by hardware; and the firewall for detecting unauthorized access based on a set access control policy, designating the address of the source of the detected unauthorized access, transmitting to the router a command for cutting off the source address of unauthorized access to the router, and setting a filtering policy, thereby automatically setting by the router discarding a packet from the address of unauthorized access.

According to the present invention, when a firewall detects unauthorized access, the firewall automatically sets the router to discard a packet from the address of the source of the unauthorized access. By the firewall automatically setting the router, a high-speed packet discarding operation by hardware can be realized. Since the line between the router and the firewall admits no unauthorized packet, authorized access can be constantly accepted.

According to the present invention, since unauthorized access control can be performed with a firewall cooperating with a router, a high-speed and high-level unauthorized access rejection control can be realized.

### BRIEF DESCRIPTION OF THE DRAWINGS

FIG. 1 is an explanatory view of the operation performed when a DOS attack is detected by a firewall according to an embodiment of the present invention;

FIG. 2 is an explanatory view of the operation performed after a DOS attack is detected by a firewall according to an embodiment of the present invention;

FIG. 3 is an explanatory view of the operation performed when a DOS attack is stopped according to an embodiment of the present invention;

FIG. 4 is an explanatory view of an operation environment according to an embodiment of the present invention;

FIG. 5 is a table showing the information set for a firewall by an operation administrator as environment definition information;

FIG. 6 shows an example of the information entered in an FW apparatus as the firmware or software of the FW apparatus according to an embodiment of the present invention;

FIG. 7 shows an example of a table of the FW in which the presence/absence of a use of the DOS/DDOS protection capability provided by the FW apparatus is set as a policy;

FIG. 8 shows an example of a table stored in the FW for management of the status of the DOS/DDOS attack detected by the FW and the specification status for the router;

FIG. 9 is a flowchart (1) showing the flow from the confirmation of the continuity of a filtering instruction to a router from the time when the FW detects a DOS/DDOS attack as shown in FIG. 9 until the release when the attach stops;

FIG. 10 is a flowchart (2) showing the flow from the confirmation of the continuity of a filtering instruction to a router from the time when the FW detects a DOS/DDOS attack as shown in FIG. 9 until the release when the attach stops.

### DESCRIPTION OF THE PREFERRED EMBODIMENTS

According to the embodiment of the present invention, the following configuration is designed.

(1) The function of designating a source IP address when an abnormal condition is detected in a firewall, and automatically setting a filtering policy for a router in a LAN using a filtering command used by the router is implemented in the firewall.

(2) Means for confirming an unauthorized access status is provided by obtaining a packet discard status by a filtering operation of a router in a LAN as statistical information about a packet discard status in a firewall using a command, notifying an operation administrator of the statistical information, and therefore monitoring only the firewall.

(3) For the filtering policy set in the router in (1) above, the presence/absence of the continuity of the abnormal condition is periodically confirmed by the operation described in (2) above, a command for releasing the filtering policy automatically set in (1) above is input when a predetermined threshold of exiting an abnormal condition is not reached, thereby recovering to a normal condition.

(4) The operations (1), (2), and (3) above are guaranteed by reserving a dedicated communications line (VLAN, etc.) for reservation of a band between a router and a firewall.

(5) When a firewall is connected through a plurality of routers, all routers are entered in advance in the firewall, and the operations of (1), (2), and (3) are performed on all routers when a DOS/DDOS (denial of service/distributed denial of service) attack is detected.

By discarding an unauthorized packet transmitted by a DOS/DDOS attack, the large occupation of the capacity of the circuit between a router and a firewall can be avoided, thereby constantly and correctly accepting authorized access.

The embodiment of the present invention is described below by referring to the attached drawings.

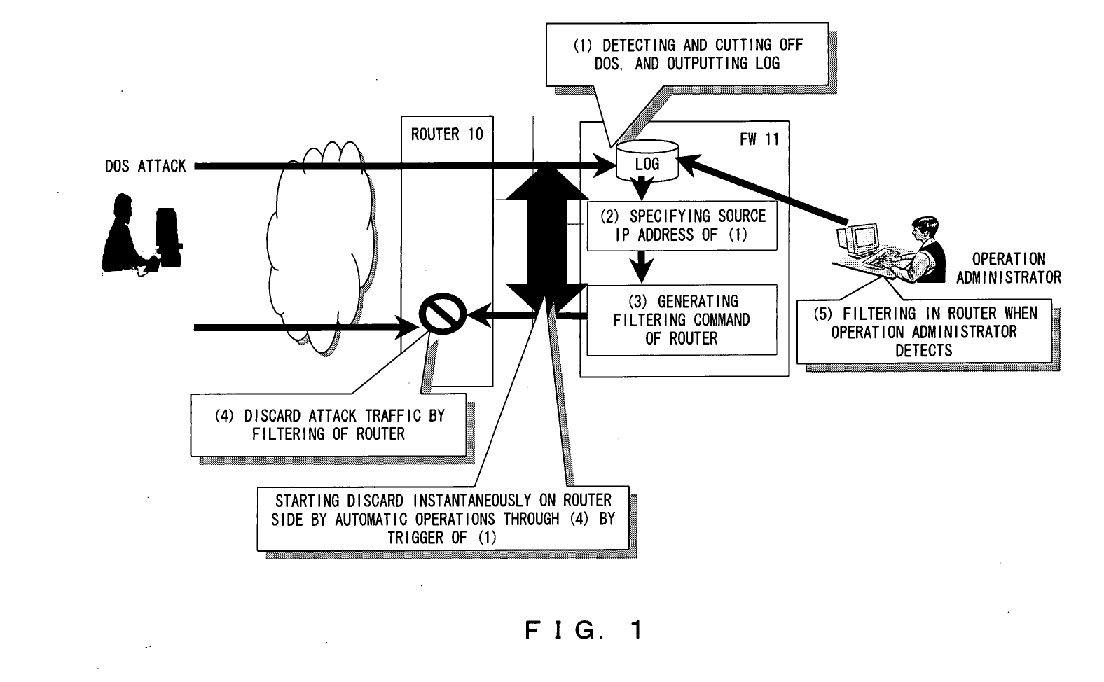

FIG. 1 is an explanatory view of the operation performed when a DOS attack is detected by a firewall according to an embodiment of the present invention.

When a firewall 11 (hereinafter referred to as an FW) detects a DOS/DDOS attack based on the preset filtering policy (1), it outputs a log and simultaneously designates the source IP address of the unauthorized access packet (2).

In the FW 11, the name of the interface of the external connection network of a router 10, and the filtering command format of the router 10 are entered in advance, a filtering command of the router is generated using the source IP address designated in (2) above as a key, a remote connection to the router is performed for a command operation, and then the command is set in the router (3). In the router 10, the subsequent DOS/DDOS attack packets are cut off and discarded based on the filtering policy set in (3) above (4). Afterwards, the operations of (1) through (4) are automatically performed. When an operation administrator detects unauthorized access by checking the log of the FW 11, the FW 11 and the router 10 have filtered unauthorized access in cooperation with each other.

In the following explanation of the embodiments of the present invention, the router is assumed to be configured as follows.

1) A router has an environment realized by hardware in which a packet can be discarded by specifying a source IP address, and an instruction to discard a packet can be specified based on the command specification unique to each router. Each router stores a connection interface for an external network, a connection interface to an FW which is a repay point of a packet addressed to a server, and a dedicated interface for operation management (setting a filtering policy, and confirming a status) of the router apparatus. The router can be formed by a plurality of units, and different router models can be combined.

2) The operation management interfaces of a router and an FW are interfaces between the router and the FW which is independent of an interface for use in communications between an authorized user and a server, and does not share a band with the traffic of an inter-server communications interface. For example, different physical lines are used, a VLAN is divided on the same cable, and a band is reserved exclusively for operation management, etc.

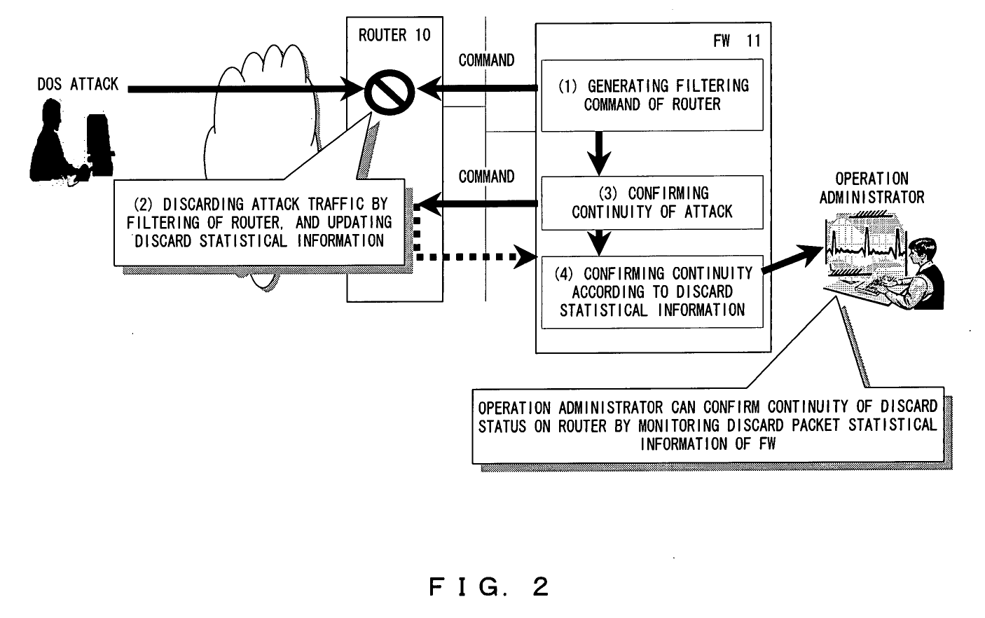

FIG. 2 is an explanatory view of the operation performed after a DOS attack is detected by a firewall according to an embodiment of the present invention.

After the router 10 cuts off the DOS/DDOS attack based on the filtering policy set in the router 10 in (1), the filtering status display command of the router 10 is periodically input from the FW 11, thereby confirming the presence/absence of the increase in the number of discarded packets (3), accumulating the information obtained by the status display command corresponding to the rule of the filtering policy (DOS/DDOS attack and protection policy) of the FW 11, inputting a confirm command by an operation administrator for a virtual node for confirmation of the continuity of the attack, and receiving (4) statistical information about a discard status. Therefore, the operation administrator can confirm the status only by operating performed on the FW 11 without considering whether or not the FW 11 offloads filtering control to the router (transferring the packet discarding process from the FW 11 to the router 10).

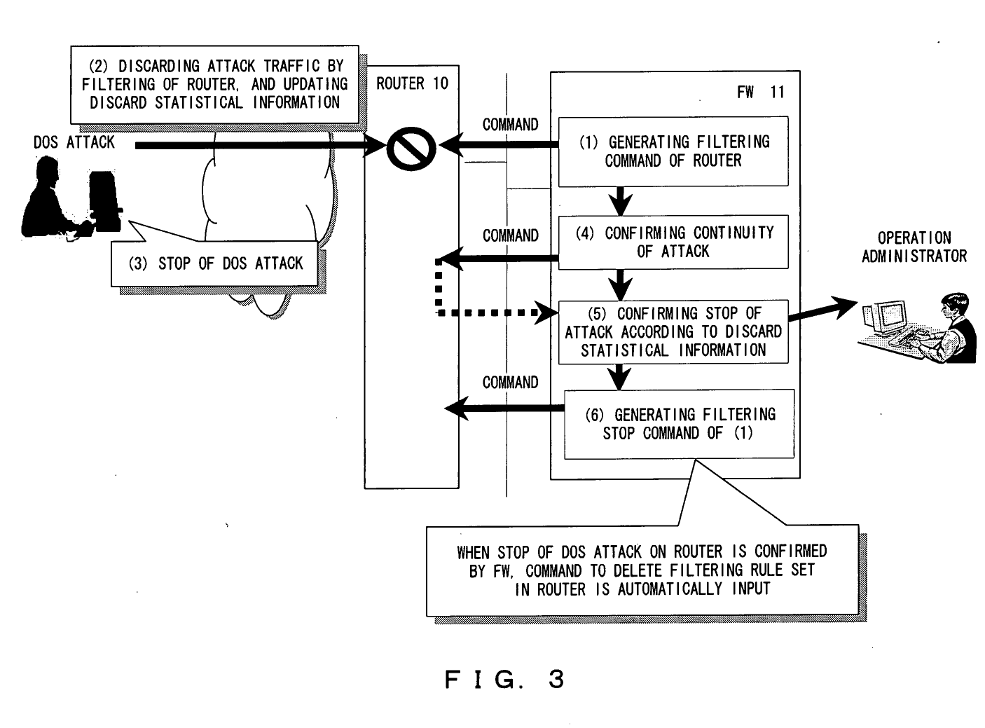

FIG. 3 is an explanatory view of the operation performed when a DOS attack is stopped according to an embodiment of the present invention.

A filtering policy is set from the FW 11 to the router 10 in (1). When an attack stops in the status in which a router discards a packet corresponding to an attack traffic (3), the firewall (FW 11) inputs a command to release a policy set automatically in (1) when the release recognition condition (the number of attack packets per time is equal to or smaller than the threshold, and a predetermined time has passed, etc.) of the attack status set in advance in the FW 11 is satisfied, thereby automatically protecting against continuity of excess load in a normal status.

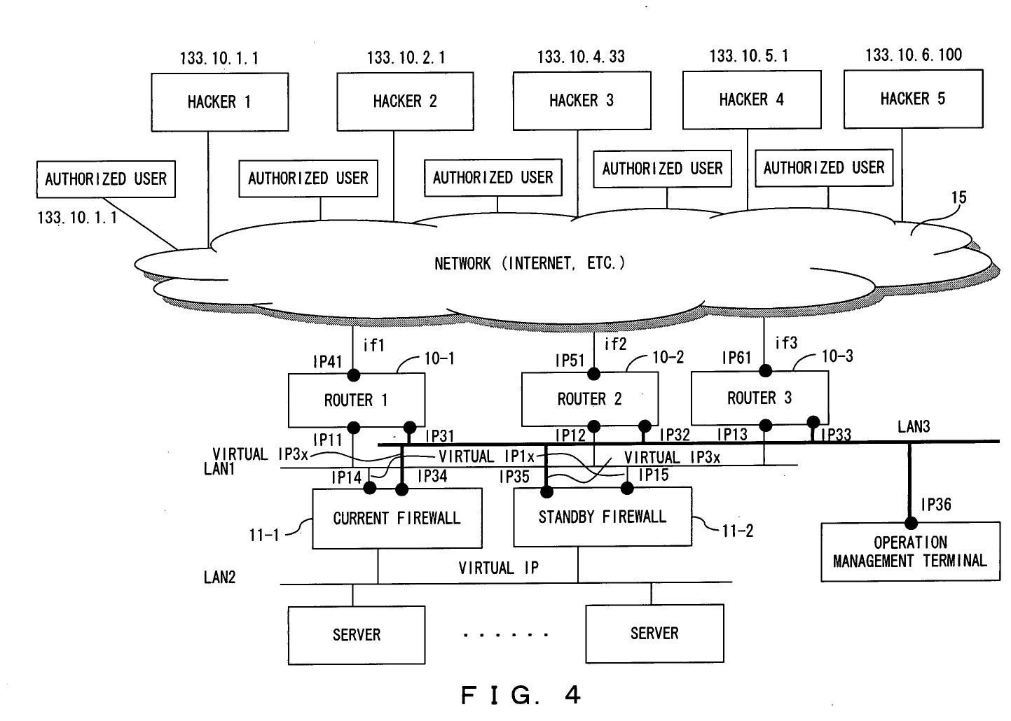

FIG. 4 is an explanatory view of an operation environment according to an embodiment of the present invention.

The numerals and symbols assigned to hackers 1 through 5, an external network, routers 1 through 3, a current FW apparatus, a standby FW apparatus, an operation management terminal, etc. are examples of identifiers specifying an apparatus such as an IP address, etc. The explanation is given below by referring to the attached drawings.

There are routers 10-1 through 10-3 explained in the embodiment of the present invention and FWs 11-1 and 11-2 between an external network 15 such as the Internet, etc. in which access from an authorized user and hackers attempting to get unauthorized access (malicious access) exist in a mixed manner and a server which is the destination of access from each user. The routers 10-1 through 10-3 can specify the discard of a packet using a source IP address by a command of hardware (chip). Furthermore, each of the routers 10-1 through 10-3 holds a dedicated interface for operation management (setting a filtering policy, and confirming the status) of the connection interface and the router apparatus for the external network 15. Furthermore, the routers 10-1 through 10-3 can also be realized by a plurality of units, or by combining different router models. The FWs 11-1 and 11-2 can be configured by one or two units (when the reliability of the FW is enhanced), and hold an interface directly connected to the routers 10-1 through 10-3, a connection interface to a server, and a dedicated interface for operation management (DOS/DDOS attack and protection policy, router cooperative environment setting, DOS/DDOS attack and protection status confirmation) of an FW. The operation management interfaces of the routers 10-1 through 10-3 and the FWs 11-1 and 11-2 are independent of the interface for use in the communications between an authorized user and a server (hereinafter referred to as business communications), and do not share a band with the traffic of a business interface (different physical lines are used or a VLAN is separate on the same cable, and a band is reserved exclusively for operation management).

The two FWs 11-1 and 11-2 can be used in a hot standby operation. In this case, for an interface for business communications, a common IP is assigned to two firewalls (hereinafter referred to as FWs) common to each network on the router and server sides, and the IP is stored as a virtual IP by the FW 11-1. In the operation management interface, a common IP is assigned, and an operation administrator operates the IP as an operation target FW, thereby holding the function of eliminating the necessity to be aware of the two FWs and the operation status (current and standby) of the FW.

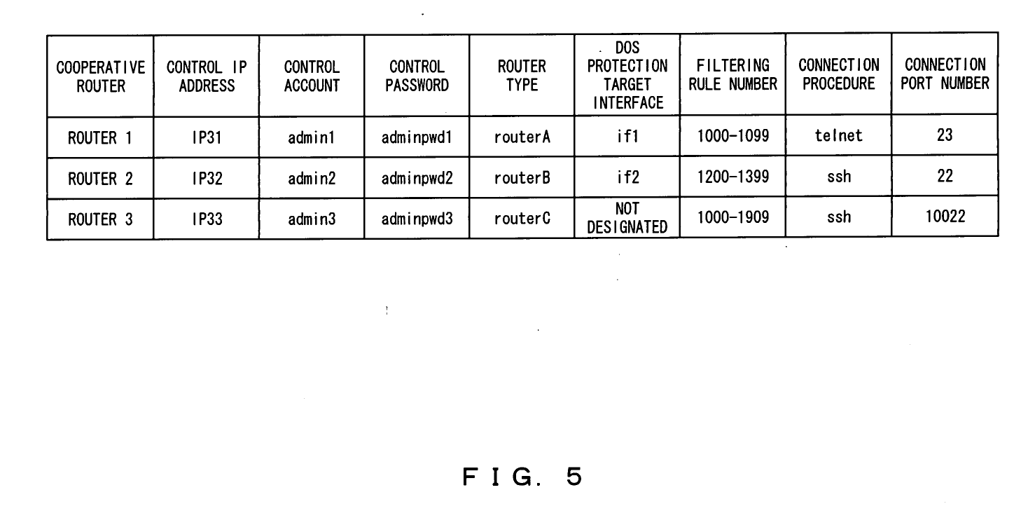

FIG. 5 is a table showing the information set for a firewall by an operation administrator as environment definition information. The contents of the table shown in FIG. 5 are set according to the information shown in FIG. 4.

A cooperative router is connected to an external network, and refers to the routers 1 through 3 shown in FIG. 4. Each piece of information shown in FIG. 5 is set for each of the routers. A control IP address refers to a router side IP for command control of a router from an FW, and indicates the router side IP on the operation management interface shown in FIG. 4. An account password for control is entered as authentication information in the router side when a connection is made for an operation management on each router from an FW. The connecting procedure and the connection port number refer to the port number used in making the above-mentioned connection, and the procedure of either telnet or ssh when a connection is made. The connecting procedure is either telnet or ssh supported on the router side.

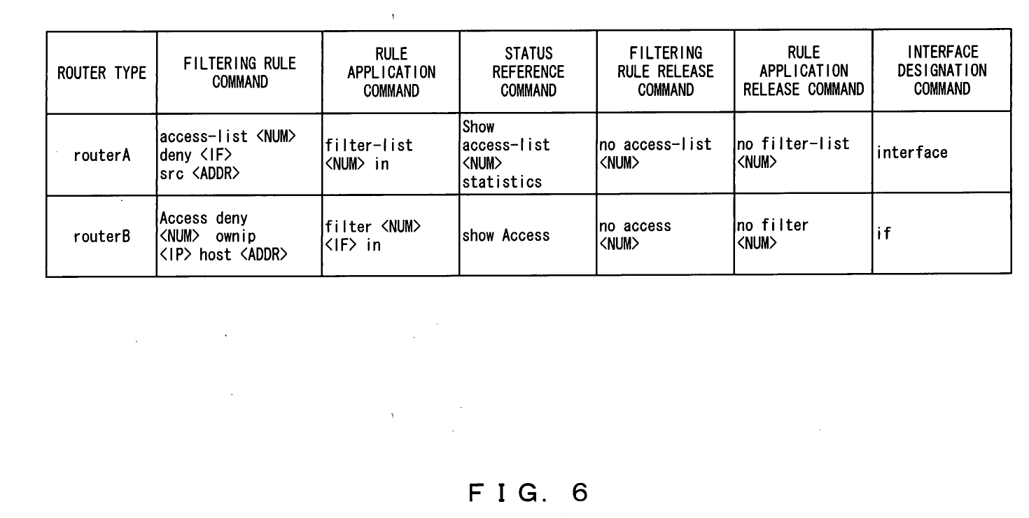

A router type refers to router type identification information for selection of an appropriate command specification when the command specification of a router provided by the function such as filtering, etc. depending on the manufacturer of a router and a model as shown in FIG. 6 as described later, and the router entered in the table implemented in the FW shown in FIG. 6 is a target router according to the present embodiment.

A DOS protection interface indicates whether or not the designation of an interface is enabled when a filtering policy is applied to a router. If the designation is enabled, the name of an external network connection interface is specified. The designation can be optionally performed depending on the router. In this case, if there is no problem with the performance on the router side, not only an external network but also all interfaces can be considered.

When a filtering rule for a router for identification of a plurality of rules is set using a command, a filtering rule number is set for storage on the FW side. Considering the case in which an operation administrator sets in advance other than in automatically setting by an FW according to the present embodiment, the filtering rule for the router is automatically set by the FW in the range of the numbers set in the present table, and the range of other numbers can be manually set by a user. Thus, the double settings between the automatic setting by the FW and the manual setting by the operation administrator can be avoided.

FIG. 6 shows an example of the information entered in an FW apparatus as the firmware or software of the FW apparatus according to an embodiment of the present invention.

The table shown in FIG. 6 is an internal table not operated by an operation administrator.

The table shown in FIG. 6 provides the identification information as a router type for the router apparatus (model) which can be cooperatively operated according to the present embodiment. When the FW expands the cooperative router model according to the present embodiment, the router type is newly added to the present table, and adds information based on the added router specification to the contents of other tables. Thus, the present embodiment can also be applied to a new router.

A command syntax according to the specification of the router is set for each router type for a filtering rule command, a rule application command, a status reference command, a filtering rule release command, a rule application release command, and an interface designation command.

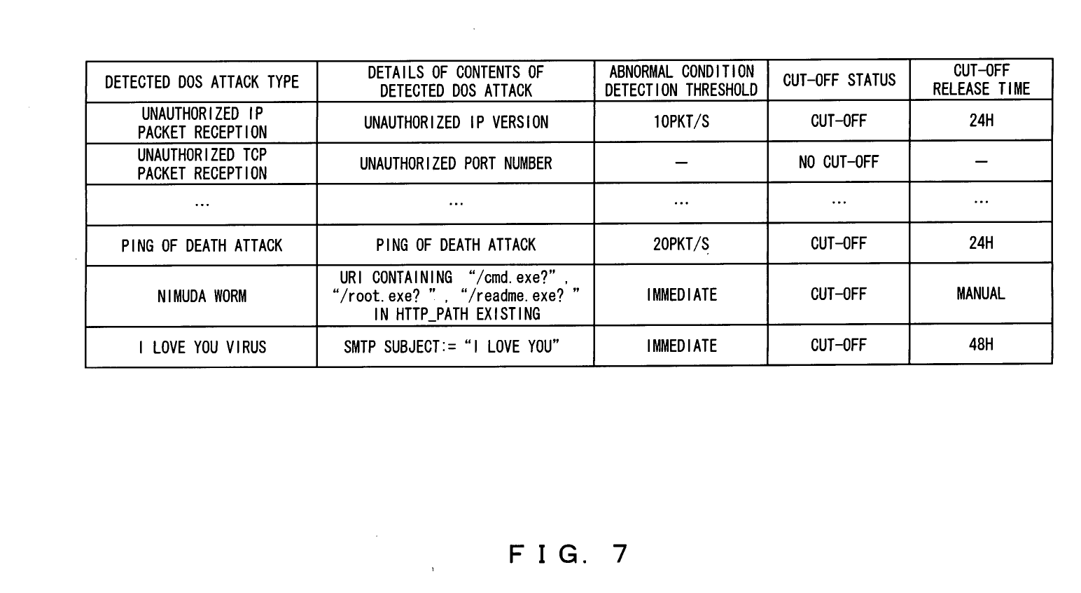

FIG. 7 shows an example of a table of the FW in which the presence/absence of a use of the DOS/DDOS protection capability provided by the FW apparatus is set as a policy.

The detected DOS attack types is a list the DOS/DDOS protection capabilities provided by the. FW apparatus. As listed in FIG. 7, unauthorized IP packet reception, an unauthorized TCP packet reception, a ping of death attack, a Nimuda worm, I LOVE YOU attack are set whose detection target/contents as detailed DOS attack are set as the detection DOS attack detailed contents. A user can specify information uniquely identified such as unauthorized IP version, etc. when the specification can be made only by selecting a unique identifier in the CLI (command line interface), when plural pieces of identification information can be selected and specified using an identifier through a GUI and CLI, and when the user individually sets the detailed information as identification pattern.

An abnormal condition detection threshold has a default value as an FW apparatus. When an operation management does not specifically specify the value, the default value is used. When the operation administrator specifically specifies each rule, the specified value is used, and reflected by the table. The setting specifies the number of received packets per second. When the number is exceeded, it can be detected. Otherwise, when only one additional packet is received, it is detected as an abnormal condition, which is referred to as immediate detection (practically 1 packet/s).

The information as to whether or not cut-off can be performed indicates whether or not an abnormal condition is recognized and cut off (discard a packet) when the number of received packets is equal to or larger than an abnormal condition detection threshold. When the information is specified as cut off, an abnormal condition occurrence message is output when an abnormal threshold is detected, and a dynamic filtering instruction is issued to the router.

A cut-off release time refers to a time from the detection of an abnormal condition to the release of a cut-off status.

When a cut-off release time passes from the abnormal condition detection time, the packet discard status of the router during the period is confirmed, and when the number of discarded packets is equal to or larger than the abnormal condition detection threshold, a filtering release instruction is not issued to the router even after the passage of the cut-off release time, and the filtering status of the router is maintained until the cut-off release time passes again from the time point.

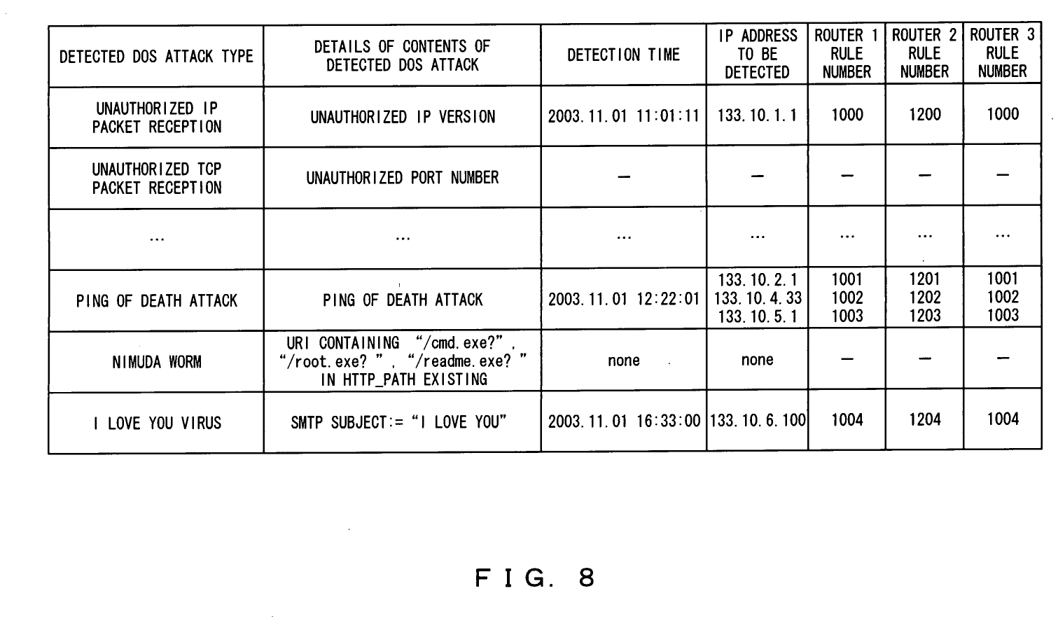

FIG. 8 shows an example of a table stored in the FW for management of the status of the DOS/DDOS attack detected by the FW and the specification status for the router.

Based on the policy table of the FW shown in FIG. 7, when a DOS/DDOS attack is detected, the detection time, the source IP address of the packet when the packet is detected, and the rule number of the filtering application instruction command issued to each router when a filtering instruction is issued to the router at the IP address are stored for each router.

The FW associates this table information with the filtering instruction command issued to the router when the DOS/DDOS attack is detected and uses it as the information for an issue of a filtering application release instruction command when an attack is released, and the information for confirmation of the continuity of an attack.

This information is status updated by the current apparatus of the FW. When it is updated, the difference information is transferred to the FW standby apparatus, and the status synchronization (guarantee of matching) is maintained between the current apparatus and the standby apparatus.

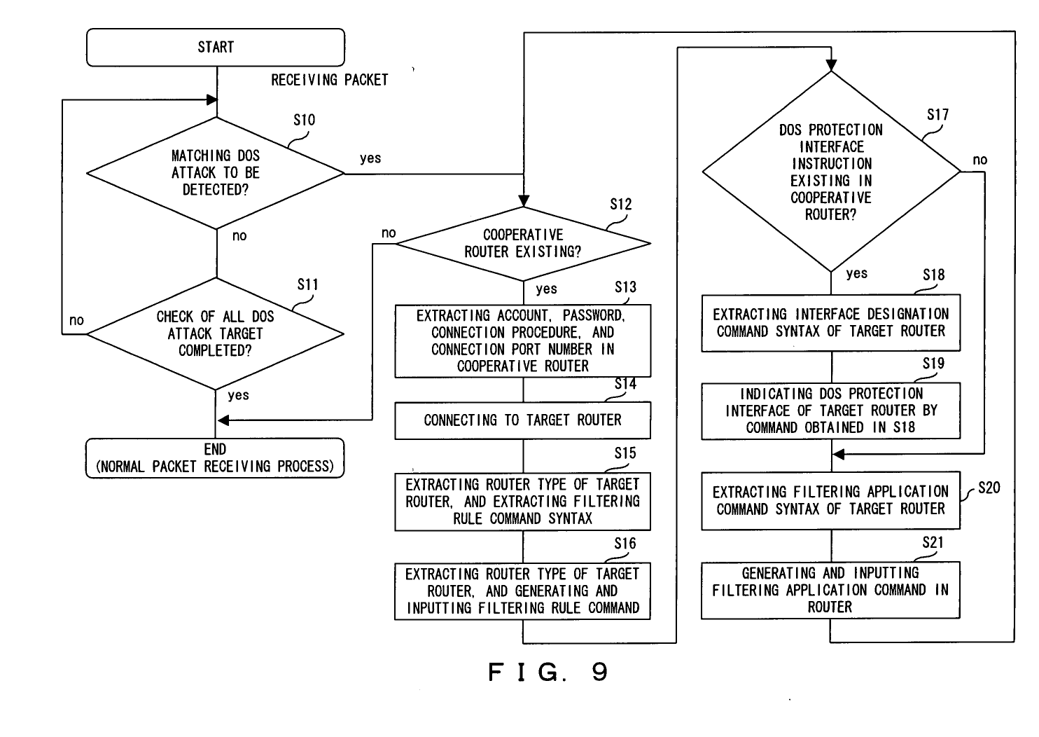

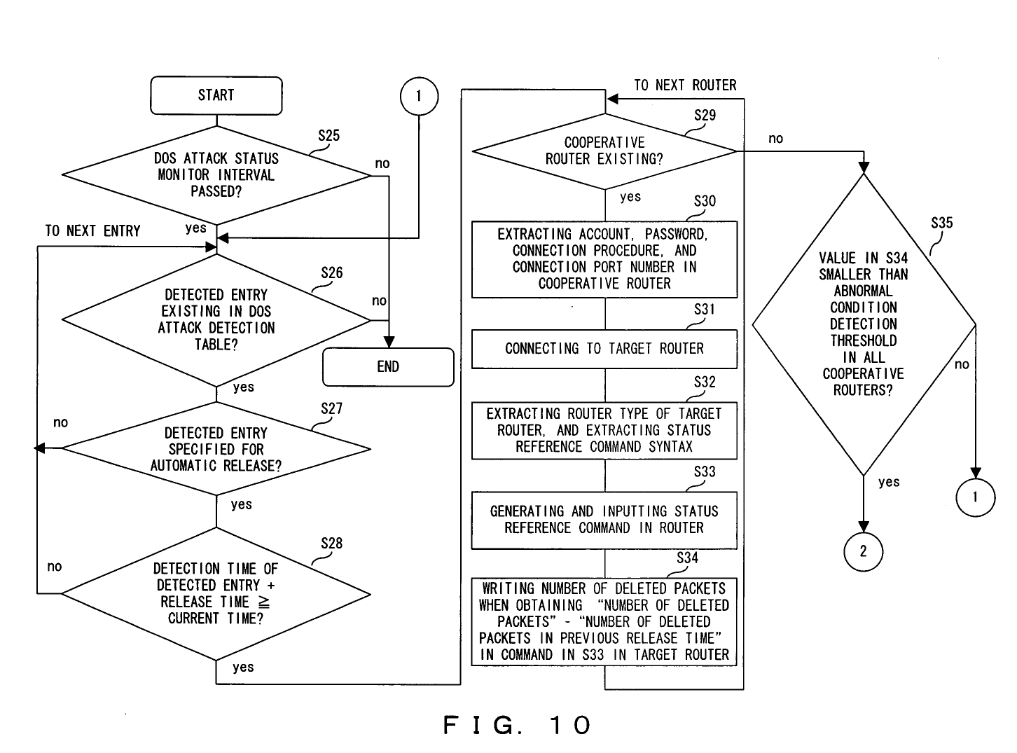

FIG. 9 is a flowchart showing the flow of the operation on the FW side from detection of a DOS/DDOS attack at the FW to the filtering instruction to the router.

Each router dynamically receives a filtering instruction command indicated by the FW as a command operation, issues a packet discard status notification by a filtering instruction command in response to the status reference command, and accepts a filtering application release instruction command. In the router, the status changes from the normal condition to the filtering application status (accepting the status confirmation command), and further to the normal condition (accepting the filtering application release instruction command).

Described below is the flow of the process shown in FIG. 9.

In step S10, upon receipt of a packet, the FW determines whether or not it refers to the DOS attack to be detected. If not, it is determined in step S11 whether or not the entire DOS attack targets have been checked. If the determination result is NO in step S11, control is returned to step S10. If the determination result is YES in step S11, the process terminates.

That is, using the table shown in FIG. 7, the matching check is made on all rows (hereinafter referred to as entries) shown in FIG. 7. If there is no matching result, the DOS/DDOS attack detecting process terminates, and the normal packet receiving process is performed.

If there is any matching result in step S10, then the number of received packets is incremented by 1, and the result is stored in the table shown in FIG. 7. At this time, when the number of received packets has reached or exceeded an abnormal condition detection threshold, FIG. 5 is referred to, and the operation of the filtering application instruction is started. If an abnormal condition is detected, it is determined by referring to the table shown in FIG. 5 whether or not it is necessary to discard the abnormal packet thereafter in the router. If there is any entry in FIG. 5, the filtering application instruction is started on the router specified in each entry (step S12).

In the process in step S12, as a preparing process for specifying as a command a filtering application instruction for each router, a connection is made to each router using telnet or ssh by referring to FIG. 5. The connecting procedure for the router, the port number, the control IP address, the account password information are all shown in FIG. 5 (steps S13 and S14)

If the connection to the router corresponding to the entry being processed has been completed in the process above, then the type of the router is extracted from FIG. 5, the entry shown in FIG. 6 is retrieved using the type information as a key, and the filtering rule command syntax of the corresponding router type entry is obtained by referring to FIG. 5 (step S15).

From the router filtering number shown in FIG. 5, a number other than the rule number currently being used for the router shown in FIG. 8 is extracted, the number and the source IP address of the received packet detected as an abnormal packet in step S10 are determined and are applied as filtering targets to the command syntax obtained in step S15, and is issued as a filtering rule command which can be interpreted by the router, thereby completing the rule setting to the router (step S16).

Furthermore, although it is necessary to issue a filtering application command to enter the filtering rule command as the application of a discarding operation in the rule, it can be necessary to apply to a specific interface, or it can be applied to all interfaces of the router depending on a router as described above for the DOS protection target interface shown in FIG. 5. Therefore, the settings are determined by referring to the information shown in FIG. 5 (step S17). If the determination result in step S17 is NO, control is passed to step S20. If the determination result in step S17 is YES, then control is passed to step S18.

When the DOS protection target interface shown in FIG. 5 is specified, the interface name is extracted from the field, the interface command designation format shown in FIG. 6 is extracted from the entry in which the router type of the router matches, and the interface designation command is issued to the router (steps S18 and S19).

For the router, the filtering application command syntax of the router is extracted from the entry in which the router type matches in FIG. 6, and together with the rule number of the filtering rule command set in step S16, the application instruction is issued to the router (steps S20 and S21).

If the process in step S21 is completed, and there is still a router not processed yet in the entries shown in FIG. 5, then the processes are repeated from the process in step S12. If the process is completed on all entries shown in FIG. 5, the process terminates.

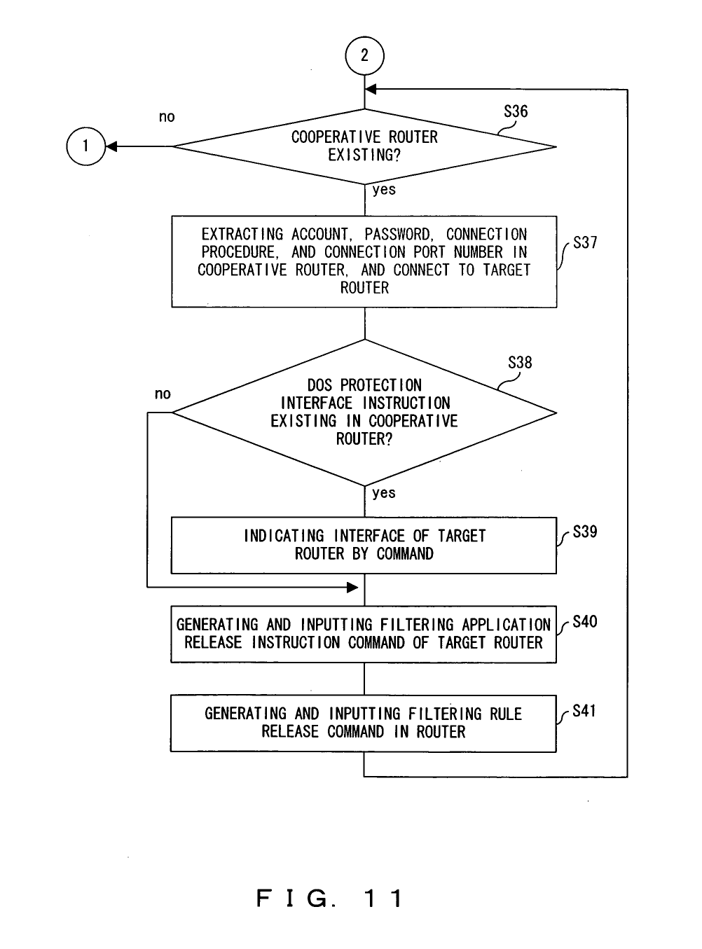

FIGS. 10 and 11 are the flowcharts showing the flow from the issue of the filtering instruction by detecting the DOS/DDOS attack in the FW to the router as shown in FIG. 9 to the confirmation of the continuity and the release when the attack stops.

The FW confirms the presence/absence of the continuity of the DOS/DDOS attack at predetermined monitor time intervals (setting changes are allowed by the operation administrator) (step S25). If the monitor time interval has not passed in step S25, the process terminates. If it is determined in step S25 that the monitor time interval has passed, then control is passed to step S26.

It is determined by referring to the table shown in FIG. 8 in the FW apparatus whether or not there is an entry for which a detection time is set (step S26). If the determination result in step S26 is NO, then the process terminates. If the determination result in step S26 is YES, then control is passed to step S27. If there is an entry in which a detection time is set, then the corresponding entry shown in FIG. 7 is referred to as the detection rule, the cut-off release time is checked, and it is confirmed whether or not it is an entry for a manual operation (step S27).

If an automatic release is indicated in step S27, it is confirmed that the sum of the detection time of the entry shown in FIG. 8 and the cut-off release time of the entry shown in FIG. 7 is equal to or larger than the value of the current time (step S28). If the automatic release is not indicated in step S27, then control is returned to step S26, and the next entry is processed.

If a specified time has passed in step S28, the process for confirmation as to whether or not the attack to the entry being confirmed by referring to FIG. 8 still continues in the cooperative router shown in FIG. 5 (step S29). If the specified time has not passed yet in step S28, then control is passed to step S26, and the next entry is processed.

If the determination result in step S29 is NO, then control is passed to step S35.

In steps S30 and S31, the connection is made to each router shown in FIG. 5 as in steps S13 to S14, the status reference command syntax of the router entry shown in FIG. 6 is extracted, and a command is issued (steps S32 and S33).

From the contents of the status reference command issued as described above, the number of deleted packets from the router shown in FIG. 5 for the entry shown in FIG. 8 is retrieved, and the number is compared with the number of deleted packets retrieved from the router shown in FIG. 8, and the increment is written to the corresponding entry shown in FIG. 8 (step S34).

After the above-mentioned process is performed on all routers shown in FIG. 5, it is checked whether or not the total number of discarded packets in each router in the entry shown in FIG. 8 obtained in step S33 is smaller than the abnormal condition detection threshold of the entry shown in FIG. 7. If it is smaller than the threshold, the following processes are performed for transfer to the discard release status. If it is equal to or larger than the threshold, then it is necessary to continue the discard status. Therefore, no process is performed, and control is returned to step S26 to continue the confirming process on the next entry shown in FIG. 8.

If it is necessary to release the discard status in step S35, the filtering application release command and the filtering rule release command are input to each router shown in FIG. 5.

That is, in step S36 shown in FIG. 11, it is determined whether or not there is a cooperative router. If the determination result in step S36 is NO, then control is returned to step S26 shown in FIG. 10. If the determination result in step S36 is YES, then the account, the password, the connecting procedure, and the connection port number are extracted in the cooperative router in step S37 for connection to the target router. It is determined in step S38 whether or not there is an instruction of a DOS protection interface in the cooperative router. If the determination result in step S38 is NO, control is passed to step S40. If the determination result is YES, then control is passed to step S39.

In step S39, the interface of a target router is indicated by a command. In step S40, the filtering application release instruction command of a target router is generated and input. In step S41, the filtering rule release command in the router is generated and input, and control is returned to step 36. According to the embodiment of the present invention, the following effect is realized.

When an abnormal condition is detected in a firewall, the discard of the traffic is automatically indicated to the router. Therefore, although a DOS attack continues for a long time, the communications can continue without lowering the performance of the firewall.

According to the embodiment of the present invention, the following effect can be obtained.

An operation administrator can determine the continuity of unauthorized access only by checking the packet discard status of a firewall, and it is not necessary to determine from the result of checking a plurality of apparatuses, thereby shortening the time required to check the apparatus, and reducing determination mistake.

Based on the packet discard status in the firewall and the router determined at the firewall by the operation administrator setting in advance the unauthorized access status release condition, a normal condition can be automatically restored. Therefore, the management cost of the operation administrator can be reduced.

In the status in which a firewall detects a DOS/DDOS attack, and heavy traffic occurs in the communications line, the setting of the filtering policy for a router can be guaranteed, thereby avoiding an operation stop time.

When a firewall is connected through a plurality of routers, and when a firewall detects a DOS/DDOS attack, the operation stop time can be avoided by applying a filtering policy to all routers.

1. An unauthorized access control apparatus for controlling unauthorized access with a router connected to an external network cooperating with a firewall connected to the router, comprising:
a router specifying an address of an access source and discarding a packet transmitted from an address by hardware; and
a firewall detecting unauthorized access based on a set access control policy, designating the address of the source of the detected unauthorized access, transmitting to the router a command for cutting off the source address of unauthorized access to the router, and setting a filtering policy, thereby automatically setting by the router discarding a packet from the address of unauthorized access.

2. The apparatus according to claim 1, wherein
information is periodically collected from said firewall about a discard status of a packet by the router based on the filtering policy set in the router.

3. The apparatus according to claim 2, wherein
based on discard information collected from the router, it is determined whether or not a number of discarded packets is smaller than a predetermined threshold, and stops discarding a packet for the router.

4. The apparatus according to claim 1, wherein
dedicated communications are established to automatically setting packet discarding from the firewall to the router between the router and the firewall.

5. The apparatus according to claim 4, wherein
one of said firewalls sets discarding a packet for a plurality of routers.

6. The apparatus according to claim 1, wherein
said firewall comprises a current apparatus and a standby apparatus so that when the current apparatus becomes faulty, the standby apparatus can function as the current apparatus for the faulty current apparatus.

7. The apparatus according to claim 1, wherein
said firewall receives a packet, determines whether or not there is an attack of the unauthorized access is detected, determines whether or not there is a router cooperative with the firewall, determines whether or not an interface to be protected is specified in a target cooperative router, and a packet discarding process is set in the router.

8. The apparatus according to claim 1, wherein
said firewall monitors whether or not an attack status continues or an attack stops.

9. An unauthorized access control method for controlling unauthorized access with a router connected to an external network cooperating with a firewall connected to the router, comprising:
specifying an address of an access source and discarding a packet transmitted from an address by hardware; and
detecting unauthorized access based on a set access control policy, designating the address of the source of the detected unauthorized access, transmitting to the router a command for cutting off the source address of unauthorized access to the router, and setting a filtering policy, thereby automatically setting by the router discarding a packet from the address of unauthorized access.

10. A program used to direct a computer to realize an unauthorized access control method for controlling unauthorized access with a router connected to an external network cooperating with a firewall connected to the router, comprising:
specifying an address of an access source and discarding a packet transmitted from an address by hardware; and
detecting unauthorized access based on a set access control policy, designating the address of the source of the detected unauthorized access, transmitting to the router a command for cutting off the source address of unauthorized access to the router, and setting a filtering policy, thereby automatically setting by the router discarding a packet from the address of unauthorized access.
